(19) United States
(12) Patent Application Publication
(10) Pub. No.: US 2006/0021003 A1
(43) Pub. Date: Jan. 26, 2006

(54) Biometric authentication system

(75) Inventors: Patricia A.P. Fisher, Stamford, CT (US); Adam G. Fisher, Watertown, MA (US); Bryan J. Cockrell, Brighton, MA (US); Scott D. Kopcha, Norwalk, CT (US); Matthew J. Lane, Norwalk, CT (US)

Correspondence Address: Gregory J. Battersby, Esq.;GRIMES & BATTERSBY, LLP, Third Floor, 488 Main Avenue, Norwalk, CT, 06851, US

(73) Assignee: JANUS SOFTWARE, INC

(21) Appl. No.: 11/159,884

(22) Filed: Jun. 23, 2005

Related U.S. Application Data
(60) Provisional application No. 60/582,148, filed on Jun. 23, 2004.

(51) Int. Cl. H04L 9/00

(52) U.S. Cl. 726/1

(57) ABSTRACT

A full-featured authentication framework is provided that allows for the dynamic selection of authentication modalities based on need and/or environment. The framework comprises a server responsible for handling requests for data and services from the other components, a logon module, a user administration tool and a system administration tool. The authentication framework may be used in a multi-biometric environment or one that contains a combination of any other authentication techniques. The system is built on a BioAPI framework and uses common data security architecture. A primary feature of the system of the present invention is the facilitation of the installation of authentication modalities, possibly from numerous vendors, thereby allowing for plug-and-play of new biometric functionality and additional core data security modules with no extra programming effort.

### 1. RELATED APPLICATIONS

This is a non-provisional application claiming benefit of priority of co-pending U.S. Provisional Patent Application No. 60/582,148 filed on Jun. 23, 2004 in the names of Patricia Fisher, Adam Fisher, Bryan Cockrell, Robert Jones, Scott Kopcha and Matthew Lane for “Biometric Authentication System.”

### BACKGROUND OF THE INVENTION

1. Field of the Invention

The present invention relates generally to the field of authentication systems, and more particularly to a system and method for consistently defining and maintaining policies in a multi- authentication framework, and even more particularly to such a system and method that is extensible, easily maintainable and economical for both system owners and users.

The proliferation of interconnected information systems and data is changing the way people live their lives. The explosive growth of electronic data has ushered in an era of unparalleled access to and sharing of information of all types. With this level of communication and interchange, the value of ensuring the privacy and security of valuable information, data and ideas has increased the need for strong authentication technologies exponentially.

Generally speaking, authentication can be based upon one of the following: what you know (e.g., knowledge); what you have (e.g., possession); and what you are (e.g., being). The current standard for authentication is the use of a password, or Personal Identification Number (PIN), with the security of this class of authentication method hinging upon the secrecy of the knowledge key. Ideally, the password must be complex enough that a malicious or unauthorized entity would be unable to correctly guess it within a reasonable timeframe. Based upon these limits, the use of passwords is only marginally suited to high security environments. Likewise, token-based authentication, an identification system based on something the individual possesses, has limitations as an authentication technique in that tokens must be on hand at authentication time. In a real world application, however, the tokens are often forgotten, lost or periodically damaged or broken by the user. Lastly biometrics, or identification made through unique physiological measurements, can only authenticate a subject to within level of closeness based upon quality of measure and accuracy of matching.

In addition to these different types, attention must be paid to securing the data that these authentication attempts are made against. Security is only as strong as its weakest link, and if the authentication data are exposed, the type of authentication deployed becomes inconsequential. The protection of this data is the goal of encryption. Encryption manipulates the data to prevent accurate interpretation by all but those who possess the decryption key, presumable those for whom the data are intended. The stronger the encryption, the more difficult it becomes to figure out the contents of the underlying data, but such power is usually at the cost of speed and resources.

It should of course be appreciated that with the current rate of technological advancement, the choices in each type expand on an almost-daily basis. New types of tokens are appearing, and existing ones are being equipped with more data storage and improved features. Biometric technology is steadily improving both in the hardware capture devices as well as in the matching algorithms. Every year computers become faster and more powerful, allowing older tried-and- true encryption algorithms to be broken in a much quicker fashion. New methods and stronger algorithms are being developed to keep data protected.

When taken as separate methodologies, each authentication type has its shortcomings. However, nearly all of these limitations can be mitigated through the use of a multiple authentication framework. Unfortunately, the integration effort involved leads to unacceptable amounts of administrative overhead in order to effectively deploy and maintain such a system, as well as keep it up to date with the latest technology. The ability to consistently define authentication policies, and extend authentication abilities, allows for a system that is extensible, maintainable and above all secure in a way that is economical for both system owners and users.

2. Description of the Prior Art

One of the most common apparati previously used in an authentication system is the password-based authentication of most of the computer networks, such as Microsoft Windows and the open-source Linux. While passwords are quick and convenient with no overhead such as additional hardware, they still present many risks. One is that the passwords must be complex enough so that they cannot be easily guessed by an unauthorized individual, but not so complex that the user cannot easily remember them. Compounding this drawback is the fact that the user may be on several different networks at work with different passwords, as well as on access lists for restricted labs, each with a PIN code locked door. Users may also be forced by policy to change their passwords every few weeks, while the PIN codes for the labs may be changed by management on a similar cycle. This alone also increases the workload of administrators who need to routinely reset passwords for those who forget them. And this complexity usually extends outside the work place, with many people having passwords for various online accounts and PIN codes for ATM cards and the like. But the real problem exists when people have to write down the multitude of passwords and PIN codes in an attempt to remember them. Security is breached when that list is viewed, stolen or lost and found by someone with malicious intent. Another risk with passwords or PIN codes is that they may be simply discovered by repeatedly watching an individual type or punch the code into a keyboard or keypad. Finally, passwords can very easily be told to others who may not be authorized to use the facilities they safeguard. Passwords alone are simply not adequate enough for the security that modern times warrant.

Another method frequently used in current authentication systems is to replace or augment the password with a token-based technology such as a smartcard. This requires users to not only enter a password or PIN, but to also provide the physical token device. Again, as described above, the risks of the password are still valid, but the requirement that a physical object be present makes it much more difficult to compromise the authentication. But these tokens can be periodically forgotten, lost, and damaged or broken by the user, not to mention possibly stolen by someone trying to subvert the security. This again is a draw on administrator resources as they spend time issuing temporary tokens (sometimes with reduced credentials) to those who forget them, replacing tokens that are damaged, broken or lost, and safeguarding the system so that a lost token cannot be found and used to circumvent the security of the system. All of these problems can cause a profound loss of productivity for users.

Finally, another tool often used in improving authentication is the deployment of a biometric device. Biometrics use, in a sense, a token that you always have with you, in the form of some aspect of your physiology that can be sampled and measured. Several apparati make use of one chosen biometric alone for authentication purposes, but this technique can be inadequate because of the many factors that can affect one's physiology, which factors can impact consistent measuring on a day-to-day basis. A cut on a finger may impact fingerprint-reading systems, or a cold can cause someone's voice to change slightly so that a voice-print match will fail. Remedying these problems again can be a drain on the administrator. A single-biometric system is also more prone to spoofing-type attacks in which malicious individuals try and use replicas of a valid user's physiology such as a recording of a voice or a dummy finger containing a fingerprint lifted from a surface he/she touched.

All of these previous deficiencies led to the development of a new type of system, such as the one described in U.S. Pat. No. 6,618,806, which issued to Brown, et al. on Sep. 9, 2003 for “System and method for authenticating users in a computer network.” Brown's system combines limited password authentication with a choice of several biometric technologies. The ability to use multiple biometrics greatly reduces the success of a spoofing attack. But as with the other methods and apparati, this type of system has its shortcomings as well. This system is built on a static number of biometric technologies as well as a fixed method for data storage, encryption and data transport. If one of the biometric technologies becomes unsupported or upgraded, or if administrators want the benefits of a new type of biometric, or if the encryption algorithm becomes outdated and needs to be replaced, or if users or administrators would like to move their data from the existing database to a new one, they could not achieve any of these goals. The current functionality is compiled into the system and cannot be changed without a rewrite of the code and a redeployment of the new version of the product.

Another fundamental drawback to Brown's system is in the enrollment of the system's users in the biometric modalities. Enrollment is the process that a biometric service uses to collect one or more samples of a particular aspect of one's physiology in order to create a template to use at a later time against which to authenticate. The system only provides for an administrator management interface to enroll the users of the system. In the event of the initial system installation, during the addition or migration of a large number of new users to the system, or a loss or corruption of the data, including the templates, the administrator faces a large effort in order to enroll or re-enroll the users authorized for the system.

Other examples of multiple authentication systems and methods with similar or greater limitations have been described in the prior art. For example, U.S. Pat. No. 6,715,674, which issued to Schneider, et al. on Apr. 6, 2004 for “Biometric factor augmentation method for identification systems” discloses a method of augmenting an existing token-based identification system by splicing into a data stream transmitted from a token reader to a control panel such that an acquired token factor from a user is intercepted by a biometric identification, or authentication, system that is wedged in series at a splice in the data stream. The data stream is used by the biometric identification system to prompt the user to present an anatomical feature to a biometric reader, which creates a biometric inquiry template that is transmitted to a biometric search engine, along with the acquired token factor, such as a PIN or barcode, to perform data match analysis against one or more enrollment templates associated with the acquired token factor. Similarly, U.S. Patent Application No. 20040039909, filed in the name of Cheng on Feb. 26, 2004 for “Flexible authentication with multiple levels and factors” discloses an authentication system and method having an arbiter defining a plurality of authentication levels, an authorizer for selecting an access authentication level from the defined plurality of authentication levels, and means for requesting from an authorizee permission to communicate via a portable authentication device the selected access authentication level in order for the authorizee to be authorized said access. Recently published U.S. Patent Application No. 20030163739, filed in the name of Armington, et al. on Aug. 28, 2003 for “Robust multi-factor authentication for secure application environments” discloses an authentication system utilizing multi-factor user authentication, such as the user's speech pattern or a one-time passcode, which may be provided via voice portal and/or browser input.

Of course, systems and methods incorporating only one of the authentication methods have long been known. While the biometric security methods might be more recent, there are numerous prior art references which teach various uses of biometric authentication. For example, U.S. Pat. No. 6,314,401, which issued to Abbe, et al. on Nov. 6, 2001 for “Mobile voice verification system” discloses a system having three principal components; namely, (1) a hand held transceiver for transmitting a voice pattern while moving (e.g., driving) past an (2) infra-red receiver array which receives the transmitted voice pattern, and a (3) speech enhancement and voice verification algorithm for conducting a comparison between the transmitted voice pattern and the registered voice patterns stored in the computer's memory. U.S. Patent Application No. 20040052404, filed in the name of Houvener on Mar. 18, 2004 for “Quality assurance and training system for high volume mobile identity verification system and method” discloses a security identification system including a biometric data input unit for receiving biometric data regarding a subject at a remote location, a biometric analysis unit, and a quality assurance unit for analyzing the biometric data and comparing it against known biometric data in a database at a central facility.

Other examples of primarily biometric systems include U.S. Patent Application No. 20040015702, filed in the name of Mercredi, et al. on Jan. 22, 2004 for “User login delegation” which discloses an apparatus and method using a program product to log a delegate user into an account of a principal user on behalf of the principal in response to authentication code, such as biometric data, correlated to the delegate user and U.S. Patent Application No. 20030046237, filed in the name of Uberti on Mar. 6, 2003 for “Method and system for enabling the issuance of biometrically secured online credit or other online payment transactions without tokens” which discloses a method and apparatus wherein a buyer supplies a registration biometric sample which is used to generate a registration biometric template which is stored and used to authenticate financial transactions. Verification and registration biometric templates are compared to determine if a requested financial transaction should be authorized.

Still other examples include U.S. Patent Application No. 20030006277, filed in the name of Maskatiya, et al. on Jan. 9, 2003 for “Identity verification and enrollment system for self-service devices” which discloses a method and system for authorizing a customer to perform transactions with a self-service device using a first set of biometric data regarding the customer extracted from a verification instrument and a second set of biometric data extracted directly from at least one feature of the customer; U.S. Patent Application No. 20030004881, filed in the name of Shinzaki, et al. on Jan. 2, 2003 for “Confidential information management system and information terminal for use in the system” which discloses a confidential information management system which allows users to securely obtain confidential information files containing various confidential information, which files are securely stored in the system using a minimum of confidential information; and U.S. Patent Application No. 20020091937, filed in the name of Ortiz on Jul. 11, 2002 for “Random biometric authentication methods and systems” which discloses a system and method for biometrically securing access to electronic systems by prompting a user to input at least one biometric attribute randomly selected from a user profile containing biometric attributes of the user.

As will be appreciated, none of the prior art offers the unique advantages offered by the system and method of the present invention.

### SUMMARY OF THE INVENTION

Against the foregoing background, it is a primary object of the present invention to provide a full-featured authentication framework that allows for the dynamic selection of authentication modalities based on need and/or environment.

It is another object of the present invention to provide an authentication framework that may be used in a multi-biometric environment or one that contains a combination of any other authentication techniques.

It is still another object of the present invention to provide an authentication framework that includes the ability to determine at the point of authentication, which mechanism would be most appropriate based upon what methods are installed and the level of security access needed by the user.

It is yet another object of the present invention to provide an authentication framework that reduces the administrative effort within the system to a reasonable level.

It is but another object of the present invention to provide an authentication framework that may be utilized in a large-scale system that supports numerous authentication techniques.

It is another object of the present invention to provide an authentication framework that allows for the installation of authentication modalities, possibly from numerous vendors, through a single product based on need and/or environment.

It is but still another object of the present invention to provide an authentication framework that implements the ability to publish, or install, new authentication methods based upon both want and need from remote locations on demand.

It is yet still another object of the present invention to provide an authentication framework that allows for expansion of the system with minimal interaction from both the end user and the administrators of the system.

It is but another object of the present invention to provide an authentication framework that integrates the physical and logical framework using a single security policy.

It is another object of the present invention to provide an authentication framework that manages the security policy through a sole interface for a multi-user system.

It is yet another object of the present invention to provide an authentication framework that produces a unified security approach to access to data in all possible forms, including electronic and hardcopy.

It is still another object of the present invention to provide an authentication framework that wherein the scope of authentication methods is easily expanded to thereby allow the framework to evolve as new technologies are invented and refined.

It is another object of the present invention to provide an authentication framework that includes the ability to install new authentication methods through an installation interface using a single mouse click to thereby minimize the effort required for extending the capabilities of the authentication framework.

It is yet still another object of the present invention to provide an authentication framework that allows administrators to identify, test, and manage new methods and include them in security policies for user logons.

It is but another object of the present invention to provide an authentication framework that allows for the management of authentication modalities with minimal effort from those responsible for the upkeep of the system.

To the accomplishments of the foregoing objects and advantages, the present invention, in brief summary, comprises a system for the dynamic selection of authentication modalities based on need and/or environment. The framework comprises a server responsible for handling requests for data and services from the other components, a logon module, a user administration tool and a system administration tool. The authentication framework may be used in a multi-biometric environment or one that contains a combination of any other authentication techniques. The system is built on a BioAPI framework and uses common data security architecture. A primary feature of the system of the present invention is the facilitation of the installation of authentication modalities, possibly from numerous vendors, thereby allowing for plug-and-play of new biometric functionality and additional core data security modules with no extra programming effort.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a block diagram illustrating the preferred embodiment of the system;

FIG. 2 is a schematic of the biometric identification record (BIR);

FIG. 3 is a flow chart illustrating the logon process of the current system;

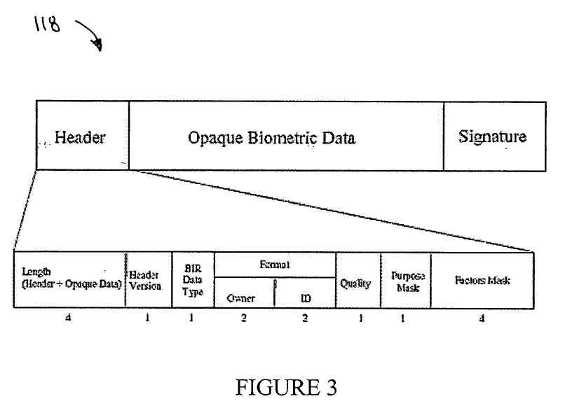

FIG. 4 is a flow chart illustrating how authentication policies can be determined based dynamically upon need and/or environment for both physical and logical access using the system and method of the present invention;

FIG. 5 is a flow chart illustrating how authentication modules may be installed dynamically into new locations using the system and method of the present invention; and

FIG. 6 is a flow chart describing a method authentication module installation with a single click interface using the system and method of the present invention.

### BRIEF DESCRIPTION OF THE PREFERRED EMBODIMENTS

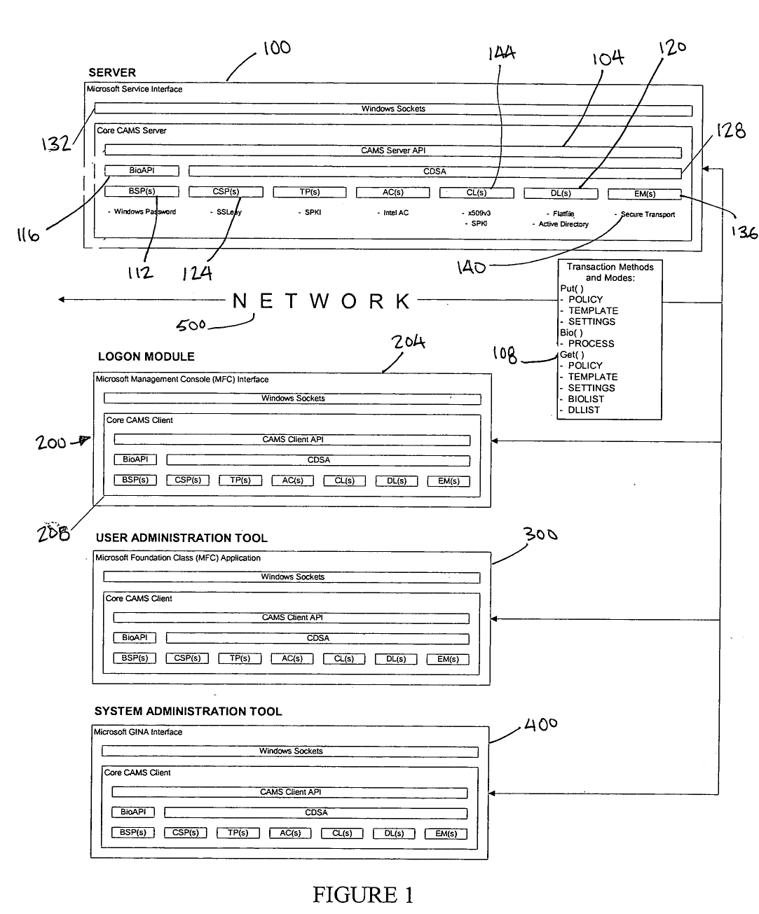

Referring to the drawings and, in particular, to FIG. 1 thereof, the authentication system of the present invention is provided and is referred to generally by reference numeral 10. The functionality of the invention is basically contained in four discreet components: the server 100, the logon module 200, the user and system configuration 300 and administration utilities 400. The server 100 is the central component for the system and handles requests for data and services from the other components. The logon module 200 provides the interface between the users and the protected system and facilitates the users' authentication onto the network. The user administration tool 300 allows for the configuration of users' authentication policy and management and creation of the users' biometric templates. Finally, the system administration tool 400 provides for the selection of the database the system uses to store, the configuration of the global default authentication policy and other functionality.

In the preferred embodiment, the server 100 contains the main functionality of the authentication system 10. At its core, the server 100 is a transaction-based system that handles discreet requests for data and services. The server 100 does not handle an entire authentication request through one continuous session. These transactions are defined and executed by the Central Authentication Management System (CAMS) 104. The CAMS 104 interface consists of three general categories of methods or modes 10: “Get,” “Put,” and “Bio.” Each of these methods 108 then contains more discreet and specific modes.

Through the “Policy” mode of the “Put” method, any client module on the system can set the authentication policy, i.e., the list of required Biometric Service Providers (BSP) 112 that must be authenticated against for access to the network 500, for a particular user on that network 500. The policy is a list of descriptive information on each BSP 112, specified by the BioAPI layer's 116 BioAPI_SERVICE_UID data structure. This information is stored in the user's table in the Data Library (DL) 120 specified in the system settings.

The “Template” mode of the “Put” method provides for the storage of a user's template, or biometric enrollment data, for a specific BSP 112. These data are returned in a Biometric Identification Record (BIR) 118 from an Enroll or CreateTemplate function call through the BioAPI 116 framework and stored in the user's table in the system DL 120. The template is encrypted using a Cryptographic Service Provider (CSP) module 124 installed into the Common Data Security Architecture (CDSA) framework 128 before it is placed into the database.

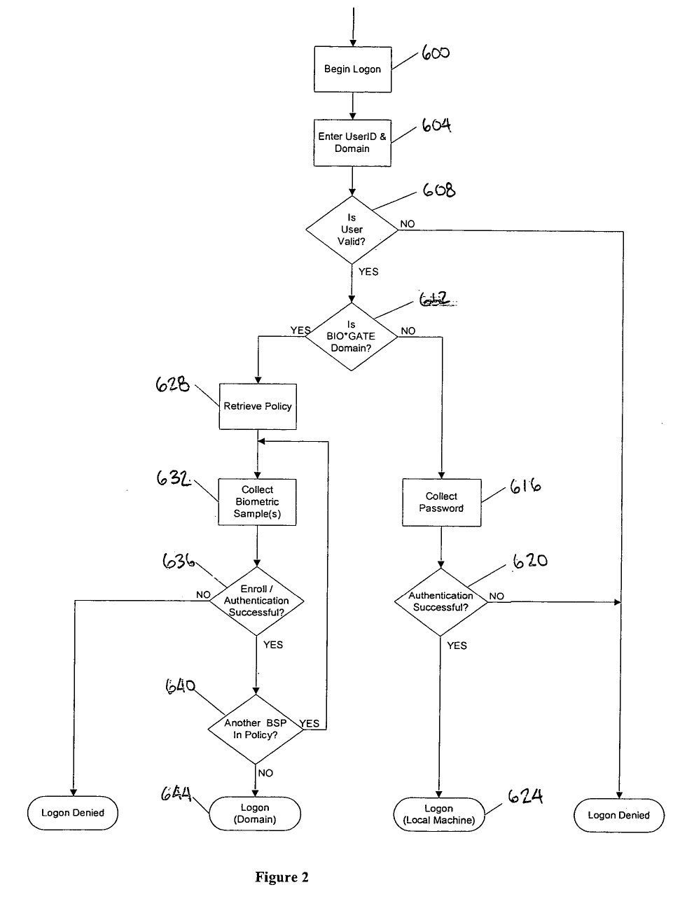

The term “biometric identification record” refers to any biometric data that are returned to the system 10. Typically, the only data stored persistently by the application are the BIR generated for enrollment (i.e., the template). The structure of a BIR is shown in FIG. 2.

The format of the Opaque Biometric Data is indicated by the Format field of the Header. This may be a standard or proprietary format. The signature is optional. When present, it is calculated on the Header+Opaque Biometric Data. For standardized BIR 118 formats, the signature will take a standard form (to be determined when the format is standardized). For proprietary BIR 118 formats (all that exists at the present time) the signature can take any form that suits the BSP. The BIR Data Type indicates whether the BIR 118 is signed and/or encrypted.

Finally, the “Settings” mode of the “Put” method allows a module (typically an administration utility) to change and update the global settings and feature configuration for the entire system 10. The desired settings are sent in a custom data structure and contain several configurable aspects of the system, including information relating to the data library module 120, the BSPs 112 and the administration of the system 10.

In the “Bio” Method, the “Process” mode enables client applications and modules to perform the actual biometric functions of the BioAPI 116. Required data for this mode include information on the user account being enrolled or authenticated, and the BIR 118 containing the biometric sample for the desired purpose. The BIR 118 may be used either for enrollment or for verification. If an enrollment is performed, the resulting template is encrypted and stored in the DL 120 table associated with the user's account.

The “Get” method includes five separate modes: the “Policy” mode, the “Template” mode, the “Settings” mode, the “Biolist” mode and the “DLList” mode. When provided with a valid network 500 user account ID, the “Policy” mode will return whether the user account has administration privileges on the network 500, and a list of the biometric actions required for that particular account. This CAMS 104 mode will first check the system settings to see if the default policy should be used instead. If so, it will use the list of BSPs 112 in the settings as the user's policy, otherwise, the user's policy is retrieved from his/her table in the DL 120. Once the policy is determined, CAMS 104 then queries the user's database table to see if he/she is enrolled for the required BSPs 112 by checking for existing templates. The list returned by this mode is a series of BIR structures 118, each of which contains information on the required BSP 112 and the action to be taken, whether to perform an enrollment or verification.

The purpose of the “Template” mode is to simply retrieve the template for the desired BSP 112 associated with the desired account. The template is the BIR 118 returned by the Enroll or CreateTemplate function of the particular BSP 112. The template is decrypted using the same CSP 124 that provided the encryption upon its retrieval from the DL 120.

The “Settings” mode returns a data structure containing the global settings and feature configuration for the system 10, as described in the “Put” method.

The “Biolist” mode is used to retrieve a list of every BSP 112 module installed in the BioAPI 116 framework layer of the server 100 processing the request. When installed, the BSP 112 registers itself with the framework's Module Directory Service (MDS) by publishing information on its properties and capabilities through a schema contained in the MDS, which is available to any application. This list returned is the schema information for each BSP 112.

The “DLList” mode is used to retrieve a list of every DL 120 module installed in the CDSA framework layer 128 of the server 100 processing the request. As with the BIOLIST mode above, the list contains the schema information for each DL 120 module.

Communication with the server 100 is achieved through standard sockets 132 and a Secure Socket Layer (SSL). Any formatting of the information communicated with the server 100 is facilitated through the use of two data structures provided through the BioAPI 116: the BIR 118 and a BIR array called BIR_ARRAY_POPULATION. All method calls into the CAMS 104 must provide at least one BIR 118 which contains specific information needed for the method to execute properly, e.g. user identification, domain name, etc. This information is placed in the biometric data field of the BIR 118. The desired mode is also written into the BIR's 118 header information. Although not truly biometric data, this custom information is placed in a BIR 118 for the ease of sending it along with the real BIRs from the BSP 112 operations.

The entire BIR array 118, along with a tag specifying the desired method, is then serialized into a byte stream for transfer through the SSL socket connection. After performing the method, the server 100 returns data in an identical fashion. The server 100 returns a BIR array 118 containing the desired information through the “Get” method, or a BIR 118 containing error information. For the “Put” and “Bio” methods, the server 100 returns an array containing a single BIR 118 that provides a status of the operation: the data field containing a Boolean TRUE for success, or a FALSE for a failure, along with specific error information.

The SLL for the socket 132 communication is provided through a custom CDSA 128 Elective Module Manager (EMM) 136 called Secure Transport (ST) 140. When the socket 132 for communication is created, a reference to it is passed into a ST module 140 instance, which contains functions for sending and receiving data through the provided socket 132. The ST module 140 encrypts the outgoing data and decrypts the incoming data using functions from a CSP module 124 and certificates, generated by the CSP 124 and Certificate Library (CL) 144 and stored in the DL 120 module; which are all installed in the CDSA framework layer 128.

In the preferred embodiment, all of this core server 100 functionality is wrapped by Microsoft's Windows Service interface, allowing the CAMS server 104 to be installed into the Windows operating system, which provides controls to start, stop and control the behavior of the service, as well as to configure it to start automatically when the computer boots. The service also has to report both logon audit information and error conditions to the Windows event logging system. It should be appreciated that while this is the current and best embodiment of the present invention, it is certainly not the only way the core server functionality can be used. It can also be integrated into any number of applications on other supported operating systems.

The main client-side application for the invention is the authentication module 204 for the network's 500 operating system. In the preferred embodiment, Microsoft's Graphical Identification and Authentication (GINA) Dynamic Link Library (DLL) interface is utilized and allows for customizable user identification and authentication procedures for safeguarding access to their operating systems from WindowsNT up to their most current. But as with the core server 100, the core for our authentication client 208 could also be contained in similar modules on other operating systems such as the Linux operating system's Pluggable Authentication Module (PAM), personal digital assistants, and mobile devices.

In the present invention, the Windows GINA is not only built on the custom CAMS interface 104, but on the CDSA 128 and BioAPI frameworks 116 as well, giving it all the capacity necessary to execute the various CAMS methods and modes 104 in a secure fashion as previously described. This GINA also supports all the necessary functionality in order for it to function in the place of Microsoft's provided MSGINA, without losing any of its abilities. It is properly driven by the Winlogon service's Secure Action Sequences (SASs), as well as providing the ability to lock the workstation, both manually and when configured to do so by the Windows screensaver. It also supports the changing of the logged in user's network password, allows for the launching of the Windows Task Manager application and allows for the user to logoff and shutdown the machine. These abilities can also be disabled or configured as required by the appropriate Windows security policies, as defined by the system administrator.

The logon procedure of the present invention is illustrated in FIG. 2. The first step in our GINA's authentication process is for the user to begin the logon by entering the Microsoft standard SAS 600. The next step is to collect the basic information on the user trying to be authenticated 604. This is achieved by displaying a window for the user to enter his/her username and to select the domain into which he/she is trying to logon.

The system then determines whether the user is valid 608, after which the domain is checked 612 to determine the type of authentication to provide. The domain will either be the one the workstation is a member of and that our system 10 is securing or the local workstation itself. If the local workstation is selected, the user is only required to authenticate with his/her network password. The user's information is sent along with our custom Windows Password BSP 112 information to the CAMS server 104 with the “Get” method and “Template” mode requested to retrieve the password for authentication against the one entered 616.

If the template does not exist, an enrollment must be performed, with the resulting template being sent to CAMS 104. If successfully authenticated 620, the user will then be allowed access to the workstation only 624. If the network domain is selected, the user's information is sent to the CAMS server 104 with the “Get” method and “Policy” mode requested 628. If successful, it means that the username provided is valid for the domain and an authentication policy was found, either one specified for the user or the default one.

Once the user's policy is retrieved, the authentication process can begin. The policy list is first traversed looking for BIRs 118 specifying that an enrollment is necessary. If any are found, the user must enroll with them before the authentication can commence.

The process for handling enrollments and verifications is extremely similar. The first step performed when handling a biometric activity is that the BSP's 112 capabilities must be looked up in the BioAPI 116 MDS. In its schema entry, the BSP's 112 supported operations are listed. If the BSP 112 supports the required functions, the GINA will get a biometric sample from the user 632, and send it to the CAMS server 104 for processing 636. The server 100 will also handle the template management. If those functions are not supported, the GINA must rely on the Enroll and Verify functions that every BSP 112 is required by the BioAPI 116 specifications to support. In this case, the template creation and matching authentication must be performed by the GINA via the Enroll and Verify functions 632, 636. In order for these to succeed, the GINA will have to send the new template from the completed Enroll call to the CAMS server 104 for storage, and similarly must retrieve the appropriate template from the server 100 to complete the Verify call. Only after all the biometric activity specified by the policy is performed and successful 640, will the user be logged onto the network domain 644.

The case for unlocking a previously locked workstation is similar to that of logging onto the domain or workstation, except that the policy does not have to be retrieved. System administrators can force the logoff of a user who has locked a workstation just as with Microsoft's GINA, but they must also authenticate using the same policy that was used to logon.

The next component in the system 10 is the user configuration and administration module or tool 300. In the preferred embodiment, the user configuration module 300 is wrapped by the Microsoft Management Console (MMC) interface, allowing it to be “snapped-in” to the Windows existing user management suite of functionality. The main purposes of this module are to assign and edit the user's policies, to manage the user's templates by providing enrollment and deletion capabilities and finally to quickly test templates by performing an authentication against the desired template. The policy management is achieved through the CAMS 104 interface's “Get” and “Put” methods' “Policy” mode.

Once the user's policy is retrieved, it is displayed in the module's Graphical User Interface (GUI). Once displayed, the administrator can add or remove BSPs 112 to the list designating the user's policy using controls provided through the GUI.

Once displayed in the GUI, a list of all registered BSPs 112 is shown, coupled with text displaying “Enrolled” or “Not Enrolled,” dependant on whether a template exists for that user. When one of these BSPs 112 is selected, the administrator can delete the template associated with the BSP 112 by clicking on the “Delete” button. Similarly, the administrator can actively enroll the present user with the “Enroll” button, which collects the sample(s) and transports the resulting BIRs 118 in the same fashion as the GINA module as described above. Finally, a “Verify” button is provided for performing an authentication against the current stored template.

The main purpose of the last major application, the system administration tool 400, in the system 10 is to view and change the system-wide settings. This is done in nearly the same way as the user configuration tool 300 handles the policy information, but by specifying the “Settings” mode instead. Once displayed in the application's GUI, the administrator can edit the configuration of the system 10 settings. The desired DL module 120 to store system data in is selected from a list of available DL modules 120, provided by a call into the CAMS 104 with the “Get” method and “DLList” mode. The database location for the desired DL 120, the administrator account name, and the FAR and FRR value can all be entered into the appropriate boxes. The FAR precedence and default policy usage Boolean values can both be changed to TRUE or FALSE by adding or removing the check from the appropriate box respectively. The default policy can be edited in the same fashion as through the user configuration tool by clicking on the “Adjust Default Policy” button. In addition to editing the settings information, the administrator can also delete and recreate the certificates used by the ST module 140 and delete the settings altogether in order to reset them. Once the “Save and Exit” button is pressed, a timestamp is added to the settings information data structure along with all the changes just made, and this structure is sent to the CAMS server 104.

The authentication system 10 of the present invention offers numerous advantages over the prior art. The first major difference and improvement is in regards to the password-only authentication implemented by most of the major operating systems, including Microsoft Windows 2000 (Win2K.) With these systems, the user is only ever prompted to provide the password associated with his/her account on that system. If that password is compromised, in one of the ways described earlier, all of the data that user was authorized access to becomes compromised.

The current system can not only replicate this existing feature, but can expand on it through the implementation of dynamically defined user authentication policies. The user's policy and the list of modalities required for authentication can be edited at any time by the system administrator. The policy can contain one or more of the modalities installed on the system 10 or none at all if the system's default policy is desired. These policies may contain just the typical password modality if the classic authentication is desired, or may be augmented with one or more biometric modalities, or the password can be removed from the policy altogether to achieve a pure biometric authentication. It should be appreciated, however, that the particular operating system is immaterial provided it includes the proper password functionality.

Once installed, it can be manipulated like any biometric modality installed on our system, e.g. added and removed from users' policies. This is also beneficial when porting our system to another operating system to create an additional embodiment. Because the password specific code is contained in one module, it can simply be removed from the system 10 and replaced with one to handle password functionality on the new system, all with minimal effort and no change to the core code.

The second major difference between the system of the present invention and other biometric and policy-based authentication systems is the instant system's ability to dynamically accept new biometrics and features through the pluggable interfaces provided by the BioAPI 116 and CDSA layers 128. Similar systems are designed around and built on one or even a few distinct biometric technologies, and although they may provide for dynamic policy modification using those core modalities, they are limited to only those which are present until a new version is released. Unlike this static approach, the system of the present invention allows for not only authentication technologies to be added and removed, but support technologies as well, such as database interfaces and encryption algorithms. This allows administrators of our system to stay abreast with the latest developments in technology and to remove outdated and unsupported components, all without requiring a reinstallation of a new software version. When a biometric vendor releases a new BSP 112, or another company creates a new data library 120 for the CDSA 128, the system administrator simply registers the new module with the system 10 using the provided installation program, and the new functionality will be instantly recognized by the system 10. This allows for countless authentication combinations to be achieved providing the best security while keeping the cost and effort to a minimum.

The final major difference is the ability of the users of the instant system 10 to enroll themselves in the various biometric technologies through their own terminal or workstation. Enrollments are usually the most time consuming aspect to using a biometric modality; a fingerprint system may require a user to scan all ten fingers in order to create a template. Coupled with the number of biometric modalities installed on the system 10 one could conceivably create a large bottleneck if all the users on the system 10 were required to enroll through an administrator's workstation, especially when the system 10 is first implemented or a new BSP 112 is installed. The instant system 10 allows users, after authenticating with their pre-existing password, to enroll themselves in the biometrics required by their current policy at their own workstation, saving not only the administrator's time, but their own as well. This may seem inconsequential to a small network system 500 with only a handful of users, but will be invaluable to administrators of a large-scale network 500 with many hundreds of users.

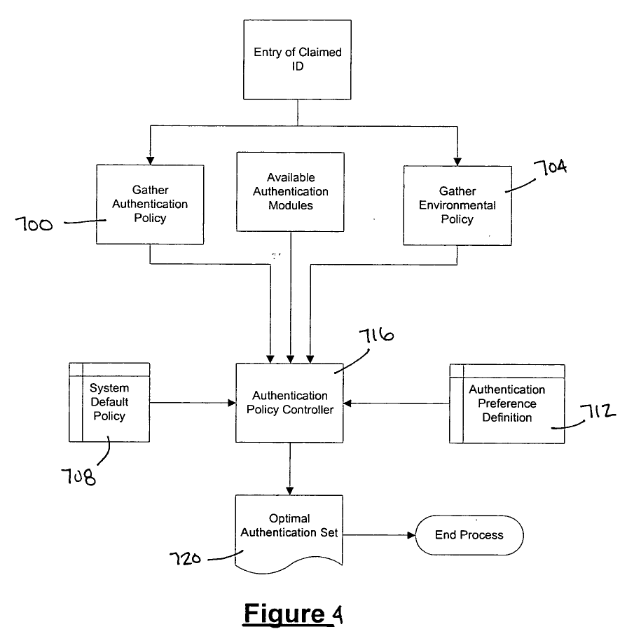

Illustrated in FIG. 4 is the logic required by the system 10 of the present invention. Whenever a user is identified, the system 10 searches for both an authentication policy 700, and an environmental policy 704. These policies are associated with the authentication point where the user is to be verified and can be either a logical access point: a computer; or a physical access point: a door. The authentication policy 700 consists of a list of authentication methods required or optional for user verification, while the environmental policy 704 consists of a credential set recommended for user authentication. Both policies may include logical operators that will help determine the total authentication required. An example of an authentication policy 700 is iris-scan and password or perhaps smartcard and/or voice-print. A minimal approach could also be taken by associating a security rating, or normalization level to the policy, in this case authentication or normalization rating must be set for each authentication module within the system 10. Both of these policies 700, 704 would be set through a management tool by system administrators prior to the access attempt but neither is required for the authentication attempt. These policies would be stored in an accessible location either locally or remotely in a defined data store. As an option the system 10 could use a meta-directory to enable various data stores for defining the location of each individual policy. Measures to ensure the confidentiality availability and integrity of policies, both in transit and storage, must also be taken.

A default system access policy 708 can also be used to determine the authentication modules needed whenever the authentication and environmental policies are unavailable. The default policy 708 can also be configured to override the authentication and/or environmental policies 700, 704 based upon the preference definition. The Authentication Preference Definition 712 defines among other items the security and normalization levels for the system. These settings enable the system 10 to use the minimal policy type. Additionally the Preference Definition also defines which policies take precedence. The definition can be applied on a system-wide or single-user scope. The available authentication modules must also be determined for the authentication point, and includes all available resources currently enabled and operating properly. These policies, or lack thereof, are communicated to an authentication controller 716, which will take all pieces of data and determine the optimal set authentication modules required for successful verification. The authentication controller 716 uses the authentication preference definition to set the guidelines of how it should make decisions. Once these guidelines have been established the authentication, environmental, and system default policies are combined logically to create an Optimal Authentication Set 720. This Optimal Authentication Set 720 is then used as the basis for acquiring authentication credentials from the user.

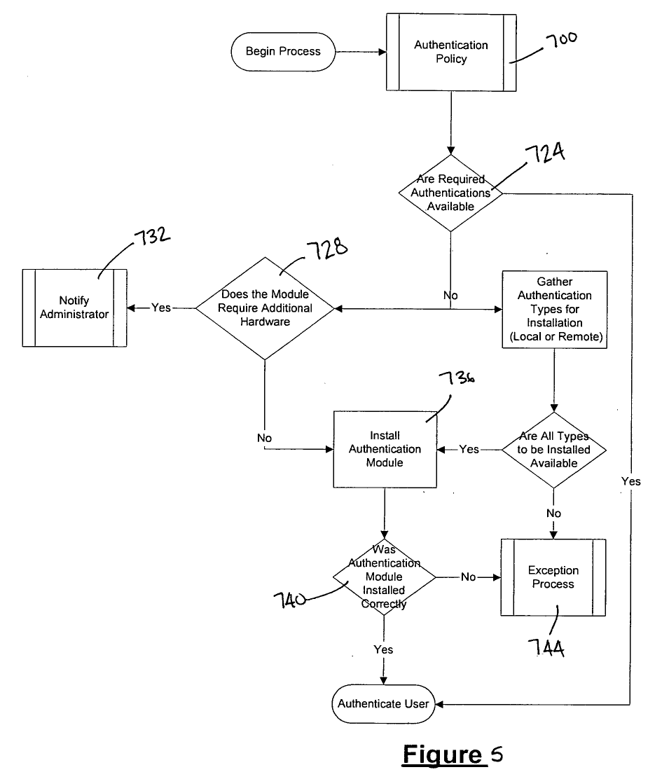

FIG. 5 illustrates the dynamic installation of new authentication modules to any authentication point within the system. Once the authentication policy 700 has been determined the availability of each authentication type must be determined 724 and stored within a data store. The data store can be either local or remote. As the modules are located the system must determine if additional hardware must be installed at the authentication point 728. This is accomplished by consulting an informational directory that includes a definition of the authentication module, such as the Module Directory Services (MDS) of the BioAPI 116. If additional hardware is required the administrator must be notified of the additional hardware needed 732. E-mail, instant messages or beepers are examples of notification systems that would fit this example. Once the location and hardware requirements have been satisfied the authentication module can be installed 736. After installation has occurred, a verification process must ensue to ensure the successful completion of the install procedure 740. If the verification procedure fails, an exception process must be initiated 744. This process can include user notification and interaction in order to mitigate any negative effects.

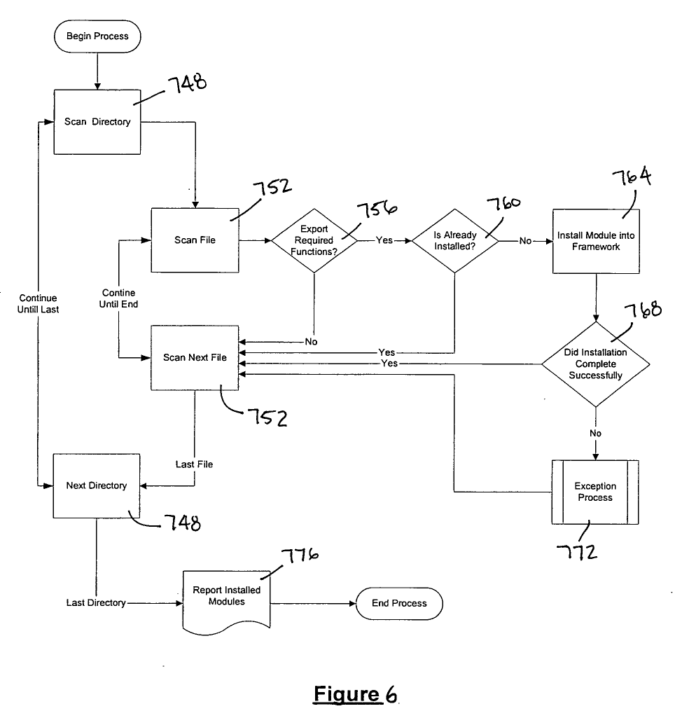

Finally, FIG. 6 defines the process required for installing authentication modalities into the defined authentication framework using but a single mouse click. The recognition and installation are completely automated processes. The premise of this installation method revolves around the ability to scan through system directory structures 748 and querying files of a certain type 752. In a Windows based system the DLL file type would be the primary example. Each file of the given type is examined for a defined set of functions that are defined as required by the installer 756. Once the file has been identified as a match, a determination of if the file must be installed is made 760. After the installation process has completed, a verification process must occur 768. If the verification procedure fails, an exception process must be initiated 772. This process can include user notification and interaction in order to mitigate any negative effects. Upon completion the results of the installation process is reported to the user and logged for audit purposes 776. The report will also notify the user if additional hardware is required in order to complete the installation.

Having thus described the invention with particular reference to the preferred forms thereof, it will be obvious that various changes and modifications can be made therein without departing from the spirit and scope of the present invention as defined by the appended claims.

For example, although the preferred embodiment utilizes Microsoft's GINA DLL interface, for which Microsoft provides documentation and sample code to aid in the design of replacement GINA modules in an alternative embodiment a custom GINA module may be used by building the GINA directly on the Application Program Interface (API) of one or more vendors' biometric technologies. Although it would be possible to create a multiple-modality logon system, the programming and effort in maintenance and upgrading this solution would not match the plug-and-play capabilities of the instant system 10.

A problem with this alternative embodiment would be in handling the various biometric technologies. It is typical of most, if not all, biometric technology vendors to provide a Software Development Kit (SDK) for use by programmers to integrate the vendor's technology into their own applications. It is also typical that the interfaces to the technology in the SDKs are proprietary to the vendor, meaning that the same function used to control one technology, will probably not work for another. The GINA would have to be written to handle each biometric in a unique way, increasing the programming effort as well as the size of the compiled module.

Another drawback to this alternate embodiment is that once the GINA DLL is compiled using these various SDKs, the included technologies are the only ones available to the system 10. A problem arises when one of the biometric vendors discontinues or upgrades one of its biometrics, or a particular user requires the features of another biometric that currently isn't integrated. To add or remove a biometric would involve a rewrite and recompile of the GINA, requiring an effort not only for the user to obtain and roll-out the new version, but for the vendor in archiving and maintaining multiple versions of the same product that contain different configurations of biometrics.

In yet another alternative embodiment, another biometric service framework may be utilized instead of the BioAPI 116, or a new custom framework may be created with similar features. A custom framework would require a tremendous effort, but could give developers the flexibility to not only create something similar to the BioAPI 116, but to augment its capabilities or even scale back some of its functionality that might not be needed. One step above this approach would be to develop the custom framework on top of an existing framework that already provides similar features to the BioAPI 116, such as the CDSA 128. The CDSA 128 in its design allows for new categories of service and functionality through the use of an EMM 136. Developers could then concentrate on the biometric aspects of their interface while relying on the CDSA 128 for pluggable module management as well as all the other capabilities the CDSA 128 provides. Taken one step further, a similar embodiment could be developed on a biometric EMM 136 that already exists for the CDSA 128, called Human Recognition Service (HRS). This interface is really just the BioAPI 116 in a CDSA EMM 136 format. It consists of the same functions with a slightly altered name, as well as a few new ones and some slightly different data structures. A developer could use this, coupled with the requisite CDSA 128, and gain all of the benefits of the BioAPI 116 with no daunting development effort put into a custom API.

Although an alternate embodiment could achieve the plug-and-play characteristics of the instant system 10 using these last few examples, there are still drawbacks to using them. The major detriment to using one of these approaches is that the BioAPI 116 is already a widely recognized and established standard and biometric technology vendors have invested heavily to support it. It is doubtful that any current vendors are producing a biometric module that supports the HRS interface and even more doubtful that they would develop a module to support another company's proprietary framework. Given that the BioAPI 116 is the standard that most vendors are opting for, it would be up to the application developers using the above approaches, to “wrap” or create a translation layer of code to interface their embodiment application with the vendors' SDKs and BSPs 112. And if any new biometric technology appearing on the market was desired by their client, they would have to develop a wrapper for it as well.

The system of the present invention, which is built on both the BioAPI 116 and CDSA 128 frameworks, allows for plug-and-play of new biometric functionality and additional core CDSA modules 128 with no extra programming effort. Additionally, new dynamic content that benefits from the CDSA's 128 features can be added with minimal development through the EMM interface 136. And with a majority of the functionality encapsulated in module form, new configurations can easily be created by adding, removing and replacing the modules, with little impact on the underlying core code.

Wherefore, We claim:

1. A full-featured authentication system comprising one or more methods of authentication and means for determining authentication policies based dynamically upon need and/or environment for both physical and logical access.

2. The system of claim 1, wherein said determination is based upon the authentication methods installed and the level of security access required by the user.

3. The system of claim 1, wherein said authentication methods are chosen from the group consisting of passwords, tokens and biometrics.

4. A full-featured authentication system that allows for expansion of the system with minimal interaction from the end user and the administrators of the system, said system comprising one or more methods of authentication and means for installing new authentication methods based upon a user's want and need from remote locations on demand.

5. The authentication system of claim 4, further including means to integrate physical and logical access thereto using a single security policy.

6. The authentication system of claim 5, further including means to manage said policy through a sole interface for a multiple user system.

7. The authentication system of claim 6, further including means to facilitate the integration of new authentication methods as they are created and refined.

8. The authentication system of claim 4, wherein said methods for authentication and means for installing are controlled by a single-click interface.

9. A method for authenticating multiple users in a network environment, said method comprising the steps of:
providing a full-featured authentication system comprising at least one method of authentication; and
determining authentication policies based dynamically upon need and/or environment for physical and logical access to said network environment.

10. The method of claim 9, wherein said at least one method of authentication is chosen from the group consisting of passwords, tokens and biometrics.

11. The method of claim 9, further including the steps of:
creating an authentication policy, wherein said authentication policy comprises at least one authentication method required for user verification;
creating an environmental policy, wherein said environmental policy comprises a credential set recommended for user verification;
creating system default policies;
communicating said policies to an authentication controller;
creating optimal set authentication modules required for successful authentication;
combinining said policies to create an optimal authentication set
identifying said user; and
authenticating said user using said optimal authentication set.

12. The method of claim 11, further including the step of dynamically installing new authentication methods.
